(19) United States
(12) Patent Application Publication
(10) Pub. No.: US 2008/0048378 A1
(43) Pub. Date: Feb. 28, 2008

(54) Gathering device with book comb

(75) Inventor: Michael David Desfosses, Deerfield, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/894,498

(22) Filed: Aug. 20, 2007

Related U.S. Application Data
(60) Provisional application No. 60/838,659, filed on Aug. 18, 2006.

(51) Int. Cl. B65H 39/00; B42B 2/00

(52) U.S. Cl. 270/52.16

(57) ABSTRACT

A gathering device is provided including a hopper, a gathering conveyor for transporting printed products, and a curved comb mounted at a side of the gathering conveyor for contacting the printed products. A saddle stitcher is also provided.

This claims the benefit of U.S. Provisional Application No. 60/838,659 filed Aug. 18, 2006 and hereby incorporated by reference herein.

### BACKGROUND

Gathering devices such as perfect binders, saddle stitchers and mailroom inserters may use hoppers or feeders to collect sheet material. A saddle stitcher or perfect binder may for example collect folded printed materials fed from hoppers or feeders onto a saddle or perfect binder conveyor, respectively, to form a magazine or other printed product. In the context of the present application, the term hopper and feeder are used synonymously.

U.S. Pat. No. 6,186,489 discloses a guide mechanism provided between a tape drive, a divert cylinder and/or a deceleration drum. The guide mechanism constrains movement of the open edge of the folded signature away from the transfer mechanism across any gap between transfer mechanisms, thereby preventing dog-earring of the open edges of the folded signatures or books at they are transferred between transfer mechanisms.

U.S. Publication No. 2004/0126163 purportedly discloses a binding apparatus having a pair of guide shafts fixed respectively to a front side plate and a rear side plate by a corresponding screw and a pair of stays fixed between the front and rear side plates, a stitcher and a clincher are movably supported in the longitudinal direction on the guide shafts, wherein a binding section for binding a paper sheet bundle is interposed between the stitcher and clincher.

### SUMMARY OF THE INVENTION

In accordance with an embodiment of the present invention, a gathering device includes a hopper, a gathering conveyor for transporting printed products. A curved comb mounted at a side of the gathering conveyor is provided for contacting the printed products.

In accordance with a further embodiment of the present invention, a saddle stitcher includes a gathering conveyor for transporting printed products, and a hopper. A curved comb mounted at a side of the gathering conveyor is provided. The comb is adjustable to change an angle at which the comb contacts printed products on the gathering conveyor.

### BRIEF DESCRIPTION OF THE DRAWINGS

A preferred embodiment of the present invention will be elucidated with reference to the drawings, in which:

FIG. 1A shows a top view of a section of a saddle stitcher according to the present invention;

FIG. 1B shows a front view of the FIG. 1 embodiment; and

FIG. 2 shows a close up view of the FIG. 1B a comb.

### DETAILED DESCRIPTION

Current book guides may consist of for example, a brass bar. The brass bar may be ½ inches square and have a bent leading edge for guiding printed products, such as sheets or books, on a gathering conveyor. In high speed gathering devices, for example, high speed saddle stitchers, corners of books or sheet material fold up on the gathering conveyor and get caught in the book guides. In the printing industry, this is known as “dog ears.”

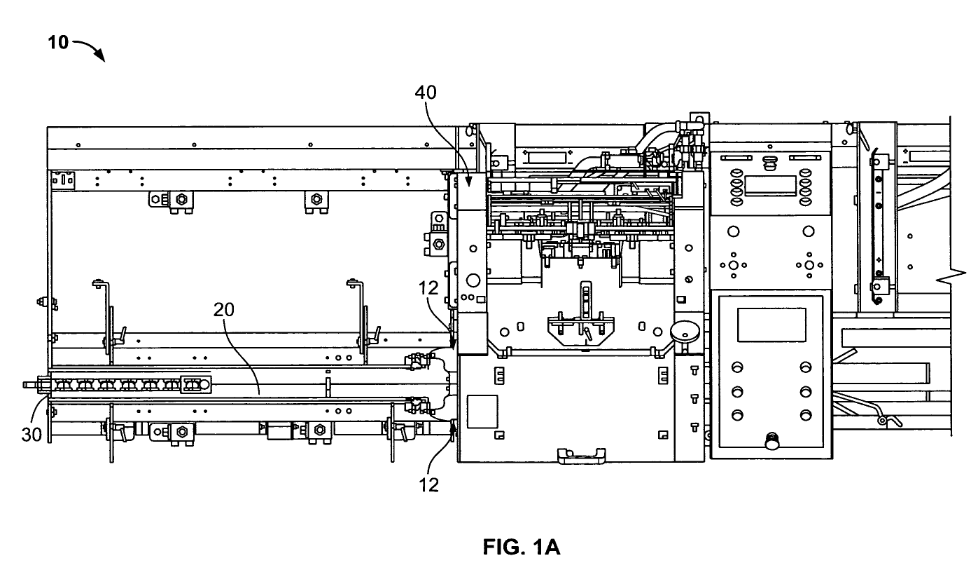

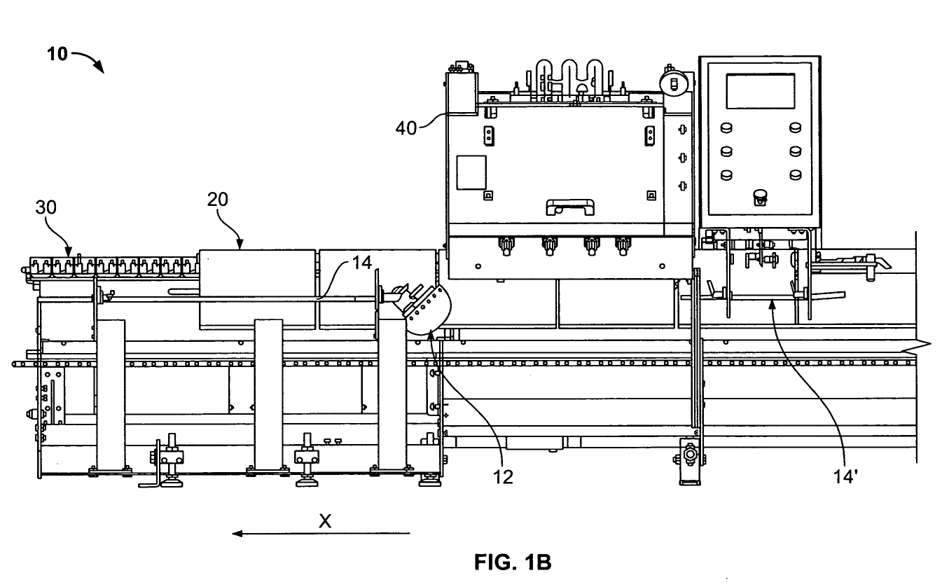

FIGS. 1A and 1B shows a gathering device, for example, saddle stitcher 10, according to an embodiment of the present invention. Saddle stitcher 10 transports printed products, for example, books 20, in a direction X. Saddle stitcher 10 includes a hopper 40, a comb 12 and a gathering conveyor, for example, gathering chain 30. Comb 12 is located aside a gathering chain 30. Comb 12 is mounted to an end of a book guide 14. Comb 12 may be, for example, a formed piece of sheet metal. Comb 2 may be made of RIGIDTEX sheet metal, from Rigidized Metals Corp., or other textured or engraved sheet metal. Other suitable materials may also be used.

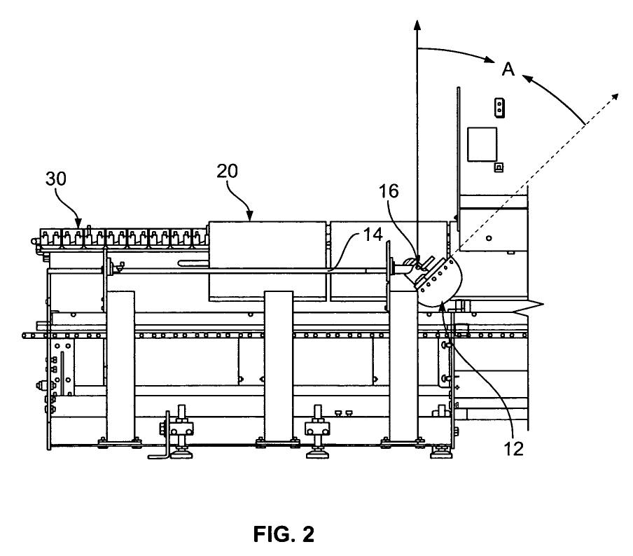

As shown in FIG. 2, comb 12 is curved in shape and fixed to a pivot 16 which permits comb 12 to be rotated an angle A from 0 to 90 degrees. The comb can also be adjusted up or down and in or out with respect to gathering chain 30, i.e. in or out of the page in FIG. 2.

Dog ears in books 20 can be combed out to ensure the entire book 20 goes under book guides 14 and down gathering chain 30.

Combs 12 may be mounted at other areas upstream, such as before a book guide 14′ (FIG. 1B). Combs may also be located at transition areas along gathering chain 30. Furthermore, combs 12 may also include holes that allow NYLON guide line to be attached.

Thus, comb 12 reduces paper jams, improves book quality and provides better mounting and control for NYLON guide lines.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A gathering device comprising:
a hopper;
a gathering conveyor for transporting printed products; and
a curved comb mounted at a side of the gathering conveyor for contacting the printed products.

2. The gathering device as recited in claim 1 wherein the gathering device is a saddle stitcher.

3. The gathering device as recited in claim 1 wherein the comb is a piece of sheet metal.

4. The gathering device as recited in claim 3 wherein the comb is a sheet metal having an engraved or textured pattern.

5. The gathering device as recited in claim 1 wherein the comb is fixed to a pivot.

6. The gathering device as recited in claim 5 wherein the comb is adjustable to change an angle at which the comb contacts printed products on the gathering conveyor.

7. The gathering device as recited in claim 6 wherein the angle is between 0 and 90 degrees.

8. The gathering device as recited in claim 1 wherein the comb is mounted on an end of a guide.

9. The gathering device as recited in claim 1 further comprising another curved comb mounted at an opposite side of the gathering conveyor.

10. The gathering device as recited in claim 1 wherein the gathering conveyor is a gathering chain.

11. The gathering device as recited in claim 1 wherein the comb includes holes for receiving guide line.

12. A saddle stitcher comprising:
a gathering conveyor for transporting printed products;
a hopper; and
a curved comb mounted at a side of the gathering conveyor, the comb being adjustable to change an angle at which the comb contacts printed products on the gathering conveyor.
